(19) United States
(12) Patent Application Publication
(10) Pub. No.: US 2005/0184860 A1
(43) Pub. Date: Aug. 25, 2005

(54) Portable information terminal controlling system and method

(76) Inventors: Maiko Taruki, Kitakyushu (JP); Tsuyoshi Nakamura, Kasuya-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/057,153

(22) Filed: Feb. 15, 2005

(30) Foreign Application Priority Data
Feb. 19, 2004 (JP) 2004-043169

(51) Int. Cl. H04B 1/40

(52) U.S. Cl. 340/441

(57) ABSTRACT

A portable information terminal controlling system of the present invention comprises the detector-transmitter and the cellular phone. The detector-transmitter includes the automobile moving state detecting unit and the control information transmitting unit. The cellular phone includes the function controlling unit, the transmitter-receiver, the display and the control unit. When the detector-transmitter detects that an automobile is moving, the detector-transmitter sends control information to a function controlling unit. When the detector-transmitter detects that an automobile is moving, the function controlling unit limits a part of a display function and a communication function of a portable information terminal, or limits all functions of the portable information terminal, and makes the portable information terminal be in a difficult state to use by giving an instruction to the control unit. Judgment of the driver's use of the portable information terminal is performed based on a signal arriving time and signal strength between the detector-transmitter and the function controlling unit, or an image extract with a camera included in the detector-transmitter.

### BACKGROUND OF THE INVENTION

1. Field of the Invention

The present invention relates to a portable information terminal controlling system that limits usage of a portable information terminal while a driver is driving an automobile, and related art thereto.

2. Description of the Related Art

Traffic accidents due to usage of cellular phones while drivers are driving automobiles have been increasing as cellular phones spread out, and it has become a social issue. In order to solve the issue from technical side, a lot of methods are proposed to limit usage of cellular phones while driving automobiles.

For example, reference 1 (published Japanese patent application H10-24808) discloses an art, which detects a moving state of an automobile and halts calling function of a driver's cellular phone when the state is judged as driving.

Reference 2 (Published Japanese patent application No. 2000-349895) discloses an art, which detects whether or not an automobile is ready to be driven and transmits shielding radio waves that shield transmission and reception of the cellular phone around the driver's seat when the automobile is judged ready to be driven.

These prior arts forbid only calling or communicating functions of the cellular phone while the driver is driving the automobile. However, cellular phones with multi-functions, such as the Internet, transmission/reception of E-mails, games, TV phones, and camera, are increasing in number in recent years. To such multifunctional cellular phones, forbidding only the calling function is not enough to completely limit usage of the cellular phone while the driver is driving the automobile. When the driver wants to use the above-mentioned functions, such as shooting pictures and playing games, in addition to the calling function, the driver has to look at the screen of the cellular phone. Thus, the driver may cause a serious traffic accident. The prior arts can not prevent usage of other functions than the calling or communication functions of the cellular phone while the driver is driving the automobile; therefore, the prior arts are not sufficient to reduce traffic accidents caused by using the cellular phone while the driver is driving the automobile.

### OBJECTS AND SUMMARY OF THE INVENTION

An object of the present invention is to provide a portable information terminal controlling system that limits usage of a cellular phone while a driver is driving an automobile, thereby beneficially preventing traffic accidents, and the related art thereto.

A first aspect of the present invention provides a portable information terminal controlling system for limiting functions of a portable information terminal used in an automobile when moving, the portable information terminal controlling system comprising: a detector-transmitter comprising an automobile moving state detecting unit and a control information transmitting unit; and a portable information terminal comprising a display unit, a transmitter-receiver, and a function controlling unit. The automobile moving state detecting unit is operable to detect moving state of the automobile and to generate control information indicating that the automobile is moving when the automobile is judged moving. The control information transmitting unit is operable to transmit the control information to the portable information terminal. When the portable information terminal receives the control information, the function controlling unit is operable to limit functions of at least one of the display unit and the transmitter-receiver.

According to the present structure, while the driver is driving the automobile, the function of the portable information terminal (for example, a cellular phone) in the automobile is limited; therefore, it contributes to prevent traffic accidents due to using the portable information terminal while driving. Items of the limitation include display limitation, communication limitation, and a halt of all the functions of the portable information terminal.

In the display limitation, display information on the display is limited by turning off the display of the portable information terminal or changing the image on the display screen into a fixed image.

The communication limitation includes limiting a communication function by halting a sending function and a receiving/answering function of the portable information terminal or limiting sending destinations to specific destinations alone (for example, emergency destinations such as a police station and a fire department).

The halt of all the functions of the portable information terminal means halting all the functions by disconnecting the power supply of the portable information terminal.

The structure according to the first aspect demonstrates its effect especially when no one but a driver is present in the automobile.

A second aspect of the present invention provides a portable information terminal controlling system for limiting functions of a portable information terminal used in an automobile when moving, the portable information terminal controlling system comprising: a detector-transmitter comprising an automobile moving state detecting unit and a control information transmitting unit; and a portable information terminal comprising a display unit, a transmitter-receiver, and a function controlling unit. The automobile moving state detecting unit is operable to detect moving state of the automobile and to generate control information indicating that the automobile is moving when the automobile is judged moving. The control information transmitting unit is operable to transmit a signal including the control information to the portable information terminal. When the portable information terminal receives the signal, the function controlling unit is operable to limit functions of at least one of the display unit and the transmitter-receiver when a driver of the automobile is judged, based on the received signal and the control information included therein, using the portable information terminal while the driver is driving the automobile.

According to the present structure, the function controlling unit, installed in the portable information terminal, can judge whether or not the automobile is moving and whether or not the driver intends to use the portable information terminal. The judgment is made based on the control information and the characteristics of the reception signal (for example, signal strength and a signal arriving time), sent from the detector-transmitter installed in the automobile. Thereby, when the driver intends to use the portable information terminal (for example, a cellular phone) while he/she is driving the automobile, either the display function or the communication function of the portable information terminal can be limited. The items of the limitation include display limitation, communication limitation, and a halt of all the functions of the portable information terminal as in the first aspect of the present invention.

According to the present structure, even when the driver and other passengers are present in the automobile, whether the driver is using the portable information terminal or one of the other passengers is using the portable information terminal can be discriminated. In short, only when the driver intends to use the portable information terminal, at least one of the display function or the communication function of the portable information terminal can be limited. Therefore, the present structure can contribute to prevent traffic accidents, while keeping convenience in use of the portable information terminal in the moving automobile.

A third aspect of the present invention provides the portable information terminal controlling system as defined in the second aspect, wherein the control information transmitting unit comprises a transmitting unit mounted at a position nearer to a driver's seat but further from other seats than the driver's seat in the automobile, and wherein the function controlling unit comprises a control information analyzer and a receiver including a receiving unit, the control information analyzer and the receiver being installed in said portable information terminal. The detector-transmitter is operable to transmit the signal including the control information to the portable information terminal, using wireless communication between the transmitting unit and the receiving unit. The control information analyzer is operable to judge whether the driver of the automobile is using the portable information terminal, by analyzing the signal including the control information received by the receiving unit.

According to the present structure of the present invention, when the transmitting unit is set very close to the driver's seat, whether the portable information terminal is close to or far away from the driver can be discriminated by the signal arriving time from the transmitting unit to the receiving unit, or the signal strength received by the receiving unit. Therefore, when the driver intends to use the portable information terminal while driving the automobile, the display function and the communication function of the portable information terminal are limited, thereby contributing to prevention of traffic accidents.

According to the present structure, it can discriminate whether a person who is about to use the portable information terminal is the driver or one of the other passengers in the automobile. Therefore, the present structure can contribute to prevent traffic accidents, while keeping convenience in use of the portable information terminal in the moving automobile.

A fourth aspect of the present invention provides the portable information terminal controlling system as defined in the second aspect, wherein the control information transmitting unit comprises a plurality of transmitting units, each of the plurality of transmitting units being mounted at different positions in the automobile, and wherein the function controlling unit comprises a control information analyzer and a receiver including a receiving unit, the control information analyzer and the receiver being installed in said portable information terminal. The detector-transmitter is operable to transmit signals including the control information to the portable information terminal, using wireless communication between each of the plurality of transmitting units and the receiving unit. The control information analyzer is operable to judge whether the driver of the automobile is using the portable information terminal, by analyzing the signals including the control information sent by the plurality of transmitting units and received by the receiving unit.

According to the present structure, whether a person who is using the portable information terminal is the driver or not can be discriminated more precisely by setting a plurality of sending units in the automobile. For example, four transmitting units, mounted in the four corners in front, rear, right and left positions of the automobile, transmit signals including individual identification information, and the receiver installed in the portable information terminal receives the signals. Then, by analyzing the signal arriving time or the signal strength from the four transmitting units, the position of the portable information terminal in the automobile can be precisely determined.

A fifth aspect of the present invention provides the portable information terminal controlling system as defined in the third aspect, wherein the transmitting unit is composed of an IC tag and the receiving unit is composed of an IC tag reader. The wireless communication between the transmitting unit and the receiving unit is performed using RFID.

According to the present structure, the fact that a driver intends to use the portable information terminal can be judged in a relatively simple manner by using the existing art. Whether a person who is using the portable information terminal is the driver or not can be easily judged by using RFID, embedding an IC tag as the transmitting unit in the wheel of an automobile, and communicating between the IC tag and an IC tag reader as the receiving unit installed in the portable information terminal. (RFID stands for Radio Frequency Identification, which is identification art using wireless frequency.)

A sixth aspect of the present invention provides the portable information terminal controlling system as defined in the third aspect, wherein the transmitting unit is composed of an infrared transmitter and the receiving unit is composed of an infrared receiver operable to receive infrared light transmitted by the infrared transmitter, and wherein the wireless communication between the transmitting unit and the receiving unit is performed using infrared communication.

According to the present structure, whether or not the driver intends to use the portable information terminal can be simply judged by using the existing infrared communication art. Whether the person using the portable information terminal is the driver or not can be simply judged by setting an infrared transmitter in front of the driver's seat, and then communicating with an infrared receiver installed in the portable information terminal.

A seventh aspect of the present invention provides a portable information terminal controlling system for limiting functions of a portable information terminal used in an automobile when moving, the portable information terminal controlling system comprising: a detector-transmitter comprising an automobile moving state detecting unit, a camera, an image recognition unit, and a control information transmitting unit; a portable information terminal comprising a display unit, a transmitter-receiver, and a function controlling unit. The automobile moving state detecting unit is operable to detect moving state of the automobile and to generate control information indicating that the automobile is moving when the automobile is judged moving. The camera is operable to take a photograph of a driver of the automobile. The image recognition unit is operable to detect an image of the portable information terminal from the photograph taken by the camera, thereby generating recognition information based on the detected result. The control information transmitting unit is operable to transmit a signal including the control information and the recognition information to the portable information terminal. When the portable information terminal receives the signal, the control information analyzer is operable to analyze the signal, and the function controlling unit is operable to limit functions of at least one of the display unit and the transmitter-receiver when the driver of the automobile is judged, based on the analyzed result, using the portable information terminal while the driver is driving the automobile.

According to the present structure, it is possible to set, for example, a small-sized camera in front of the driver's seat, and then to perform image recognition processing to the image that is taken by the camera, thereby extracting images of the driver and the portable information terminal. When the driver is detected to operate the portable information terminal while driving the automobile, either the display function or the communication function of the portable information terminal is controlled to limit the use of the portable information terminal; therefore, the present structure can contributes to prevent traffic accidents. Since the portable information terminal held by the driver can be precisely extracted, a looming malfunction of the system can be prevented.

An eighth aspect of the present invention provides the portable information terminal controlling system as defined in the first aspect, wherein the function controlling unit is operable to cut off a power supply for the display unit of the portable information terminal, thereby limiting functions of the portable information terminal.

According to the present structure, when the driver intends to operate the portable information terminal while driving the automobile, the display is turned off. The driver can not acquire new information further more, giving up the operation. Thereby, traffic accidents due to operating the portable information terminal while driving can be avoided.

A ninth aspect of the present invention provides the portable information terminal controlling system as defined in the first aspect, wherein the function controlling unit is operable to switch an image displayed on the display unit of the portable information terminal to a predetermined image, thereby limiting functions of the portable information terminal.

According to the present structure, when a driver intends to use the portable information terminal while driving the automobile, an image of the display screen is changed into an image including a warning sentence such as “Please do not operate while driving.” or a screen that is flashing in entirely mono-color, suggesting strong warning. Thus, the driver is suppressed to operate the portable information terminal while driving the automobile. Thereby, traffic accidents due to operating the portable information terminal while driving can be avoided.

A tenth aspect of the present invention provides the portable information terminal controlling system as defined in the first aspect, wherein the function controlling unit is operable to disable a sending function and a receiving function of the portable information terminal, thereby limiting functions of the portable information terminal.

According to the present structure, even when the driver tries to operate the portable information terminal while driving, the driver can neither send a message nor answer a call. Thus, the driver is suppressed to operate the portable information terminal while driving the automobile. Thereby, traffic accidents due to operating the portable information terminal while driving can be avoided.

An eleventh aspect of the present invention provides the portable information terminal controlling system as defined in the first aspect, wherein the function controlling unit is operable to disable a receiving function of the portable information terminal and to limit destinations to which the portable information terminal sends messages, thereby limiting functions of the portable information terminal.

According to the present structure, even when the driver tries to operate the portable information terminal while driving, the driver can not answer a call and can send a message only to emergency destinations such as a police station and a fire department. Thus, the driver is suppressed to operate the portable information terminal while driving the automobile. Thereby, traffic accidents due to operating the portable information terminal while driving can be suppressed.

A twelfth aspect of the present invention provides the portable information terminal controlling system as defined in the first aspect, wherein the function controlling unit is operable to cut off a power supply for the portable information terminal, thereby limiting functions of the portable information terminal.

According to the present structure, when the driver tries to operate the portable information terminal while driving the automobile, the power supply of the portable information terminal is disconnected; therefore, the driver can not use the portable information terminal. In this way, traffic accidents due to operating the portable information terminal while driving can be avoided.

A thirteenth aspect of the present invention provides a detecting-transmitting device mounted in an automobile, the detecting-transmitting device comprising: an automobile moving state detecting unit; and a control information transmitting unit. The automobile moving state detecting unit is operable to detect moving state of the automobile and to generate control information indicating that the automobile is moving when the automobile is judged moving. The control information transmitting unit is operable to transmit the control information to the exterior of the detecting-transmitting device.

According to the present structure, a detecting/transmitting device can be provided for use in the portable information terminal controlling system.

A fourteenth aspect of the present invention provides a detecting-transmitting device mounted in an automobile, the detecting-transmitting device comprising: an automobile moving state detecting unit; a camera; an image recognition unit; and a control information transmitting unit. The automobile moving state detecting unit is operable to detect moving state of the automobile and to generate control information indicating that the automobile is moving when the automobile is judged moving. The camera is operable to take a photograph of a driver of the automobile. The image recognition unit is operable to detect an image of a portable information terminal from the photograph taken by the camera, thereby generating recognition information based on the detected result. The control information transmitting unit is operable to transmit a signal including the control information and the recognition information to the exterior of the detecting-transmitting device.

According to the present structure, a detecting/transmitting device with higher precision can be provided for use in the portable information terminal controlling system.

A fifteenth aspect of the present invention provides a portable information terminal used in an automobile, the portable information terminal comprising: a display unit; a transmitter-receiver; and a function controlling unit. When the transmitter-receiver receives a signal including at least one of control information and recognition information, the function controlling unit is operable to limit functions of at least one of the display unit and the transmitter-receiver when the received signal is judged to indicate that a driver of the automobile is using the portable information terminal while the driver is driving the automobile.

According to the present structure, a portable information terminal can be provided for use in the portable information terminal controlling system. Use of the portable information terminal as a part of the portable information terminal controlling system by the driver of the automobile will contribute to suppress traffic accidents due to operating the portable information terminal while driving.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a portable information terminal controlling system in a first embodiment of the present invention;

FIG. 2 is a block diagram of a portable information terminal controlling system in a second embodiment of the present invention;

FIG. 3 illustrates a partial view in front of a driver's seat of an automobile and an outline view of a cellular phone in the second embodiment of the present invention;

FIG. 4 is a block diagram of a portable information terminal controlling system in a third embodiment of the present invention;

FIG. 5(a) illustrates a partial view in front of a driver's seat of an automobile and an outline view of a cellular phone in the third embodiment of the present invention;

FIG. 5(b) is a ground plan of the automobile in the third embodiment of the present invention;

FIG. 6 is a block diagram of a portable information terminal controlling system in a fourth embodiment of the present invention;

FIG. 7 is a ground plan of an automobile in the fourth embodiment of the present invention;

FIG. 8 is a block diagram of a portable information terminal controlling system in a fifth embodiment of the present invention;

FIG. 9(a) illustrates a partial view in front of a driver's seat of an automobile and an outline view of a cellular phone in the fifth embodiment of the present invention;

FIG. 9(b) shows an image recognition result illustrating a driver and a cellular phone detected in the fifth embodiment of the present invention;

FIG. 10 is a flowchart of the portable information terminal controlling system in the first embodiment of the present invention; and

FIG. 11 is a flowchart of the portable information terminal controlling system in the fifth embodiment of the present invention.

### DETAILED DESCRIPTION OF THE PREFERRED EMBODIMENTS

Hereafter, embodiments of the present invention are now described with reference to the accompanying drawings. In the following explanation, a cellular phone is described as an example of a portable information terminal. Of course, the portable information terminal of the present invention may be other portable information terminals, such as PDA.

(First Embodiment)

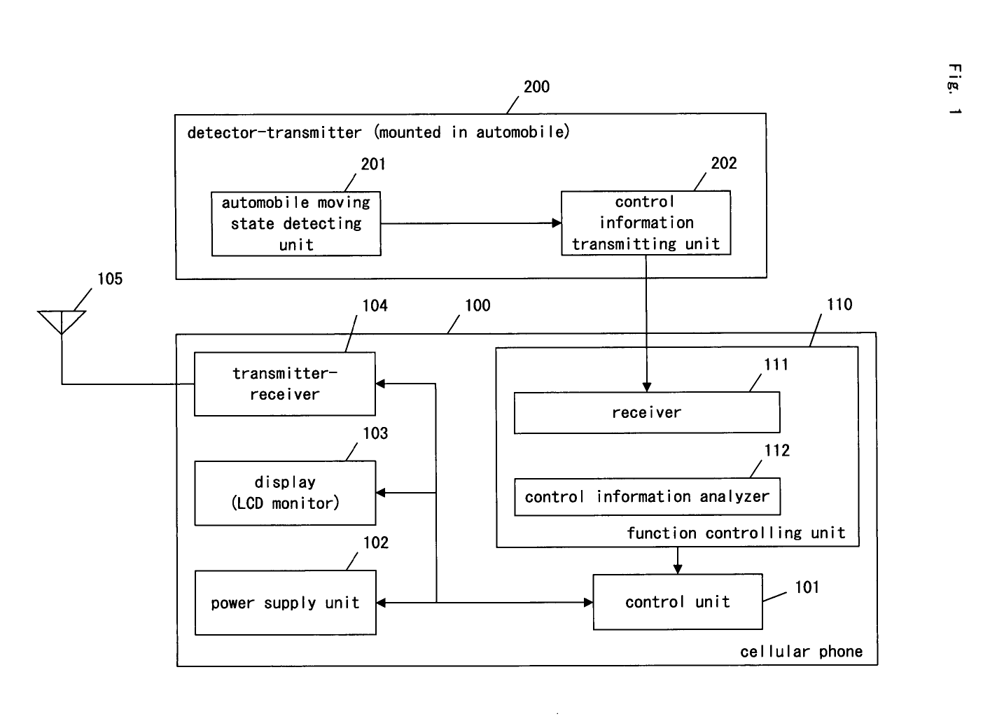

FIG. 1 is a block diagram of the portable information terminal controlling system in the first embodiment of the present invention. The portable information terminal controlling system of the present embodiment comprises a detector-transmitter 200 and a cellular phone 100. The detector-transmitter 200 possesses an automobile moving state detecting unit 201 and a control information transmitting unit 202. The cellular phone 100 possesses a function controlling unit 110, a control unit 101, a power supply unit 102, a display (for example, a LCD monitor) 103, a transmitter-receiver 104, and an antenna 105. The control unit 101, the power supply unit 102, the display 103, the transmitter-receiver 104, and the antenna 105 are basic components for the cellular phone 100 to perform regular communication.

The function controlling unit 110 includes a receiver 111 and a control information analyzer 112, and the output of the function controlling unit 110 is fed into the control unit 101.

Communication between the detector-transmitter 200 and the cellular phone 100 is performed via the control information transmitting unit 202 and the receiver 111.

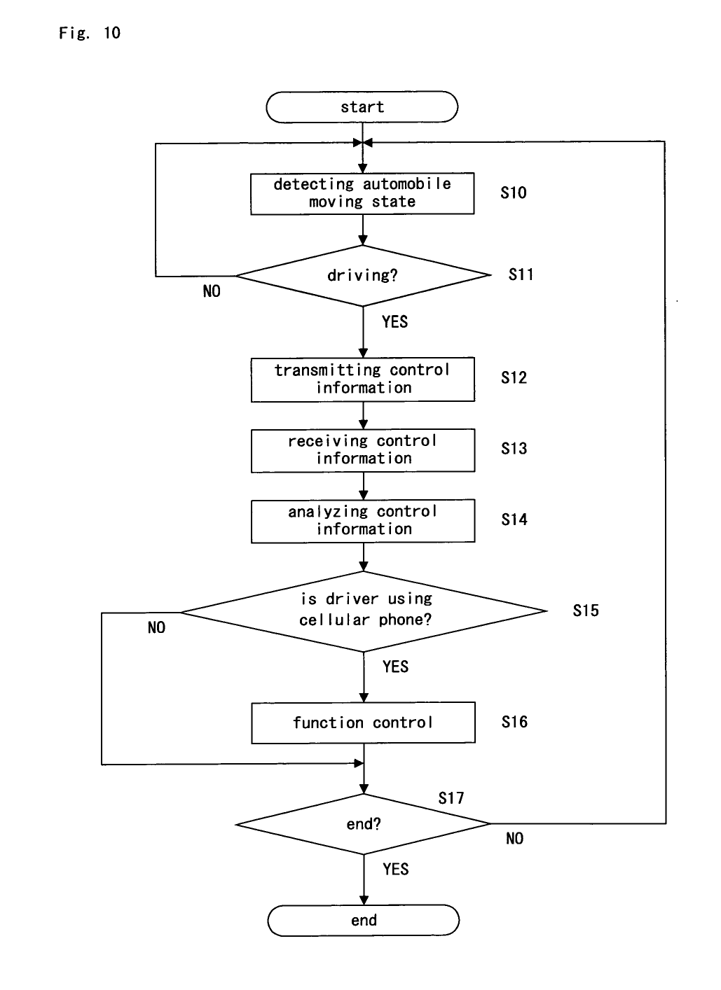

In the following, the outline for operation of the portable information terminal controlling system of the present embodiment is explained according to the flowchart shown in FIG. 10 and referring to FIG. 1.

FIG. 10 shows the flowchart of the portable information terminal controlling system in the first embodiment of the present invention.

In FIG. 10, when the portable information terminal controlling system starts operation, in Step S10, the automobile moving state detecting unit 201 of the detector-transmitter 200 detects whether an automobile is moving or not. The art, which is disclosed in the references 1 and 2, such as detecting an output of a speedometer of the automobile, can be used for the above-mentioned detection.

In Step S11, the automobile moving state detecting unit 201 judges whether the automobile is moving or not. When the automobile is judged to be moving, control information that indicates that the automobile is moving is generated, and the control information is sent to the control information transmitting unit 202. Then the process moves to Step S12. When the automobile is judged not to be moving, the process moves back to Step S10, and Step S10 and Step S11 are repeated.

In Step S12, the control information transmitting unit 202 transmits the control information, which has been sent from the automobile moving state detecting unit 201, to the cellular phone 100.

In Step S13, the receiver 111 of the cellular phone 100 receives the control information sent from the control information transmitting unit 202, and sends the contents of the control information to the control information analyzer 112.

In Step S14, the control information analyzer 112 analyzes the control information that is sent from the receiver 111.

In Step S15, the control information analyzer 112 judges whether or not a driver is using the cellular phone 100 based on the result of the analysis in Step S14. When the result of the judgment indicates that the automobile is moving and the driver is using the cellular phone 100, the process moves to Step S16. When the result of the judgment indicates that the driver is not using the cellular phone 100, the process skips Step S16 and moves to Step S17.

In Step S16, the function controlling unit 110 receives the judgment result of the control information analyzer 112, and directs the control unit 101 to limit the functions of the display 103 and the transmitter-receiver 104. Detailed contents of the function limitation, which the control unit 101 performs, are mentioned later.

In Step S17, it is judged whether or not the operation of the portable information terminal controlling system is ended. When the operation is not ended, the process moves back to Step S10, and a series of the steps mentioned above are repeated.

In above-mentioned Step S16, when the function controlling unit 110 issues a direction of the function limitation to the control unit 101, the control unit 101 controls the functions of the display 103, the power supply unit 102, and/or the transmitter-receiver 104. The control over the display 103 is to make the image on the screen disappear by turning off the power supply of the display screen, or to switch the present image on the screen to the predetermined image. The predetermined image may be a fixed image with a warning sentence such as “Please don't use this while driving.”, or a screen that is flashing in entirely mono-color, suggesting strong warning. When these images are flashing, the effect of warning can be more enhanced.

The control over the power supply unit 102 is to make the image on the screen disappear by turning off the power supply of the display screen as described above, or to make the cellular phone 100 not be used by turning off the power supply of the cellular phone 100.

The control over the transmitter-receiver 104 is to disable all sending by making the sending function of the cellular phone 100 incapable. Furthermore, the function of answering calls is made incapable; therefore, even though the driver receives an incoming call, he/she can not answer it.

When the driver tries to use the cellular phone in the automobile, the function limitation unit starts operating and the cellular phone becomes hard to use in the automobile. Thus, traffic accidents due to usage of a cellular phone while the driver is driving can be avoided.

However, from a viewpoint of ensuring safety, it is important that sending function may not be disabled completely but making emergency calls should be allowed. Thus, the sending function may be limited so as to allow sending messages to the predetermined sending destinations. For example, the limited sending destinations may include emergency contacts, such as a police station and a fire department, or a business urgent contact if the driver is driving a business-use automobile.

According to the portable information terminal controlling system of the present cellular phone, when the driver tries to use the cellular phone while driving, the function limitation unit of the cellular phone 100 starts operating, and the cellular phone 100 becomes hard to use; therefore, traffic accidents caused by operating a cellular phone while driving can be prevented.

(Second Embodiment)

The portable information terminal controlling system of the second embodiment uses RFID (Radio Frequency Identification System: radio recognition system) for communication between the detector-transmitter 200 and the cellular phone 100. RFID is a wireless access system used for reading information from an IC card or a bar code. A communication distance of RFID is several tens centimeters because RFID performs communication with a very small power at frequencies of 13.56 MHz band, 2.45 GHz band or 5 GHz band.

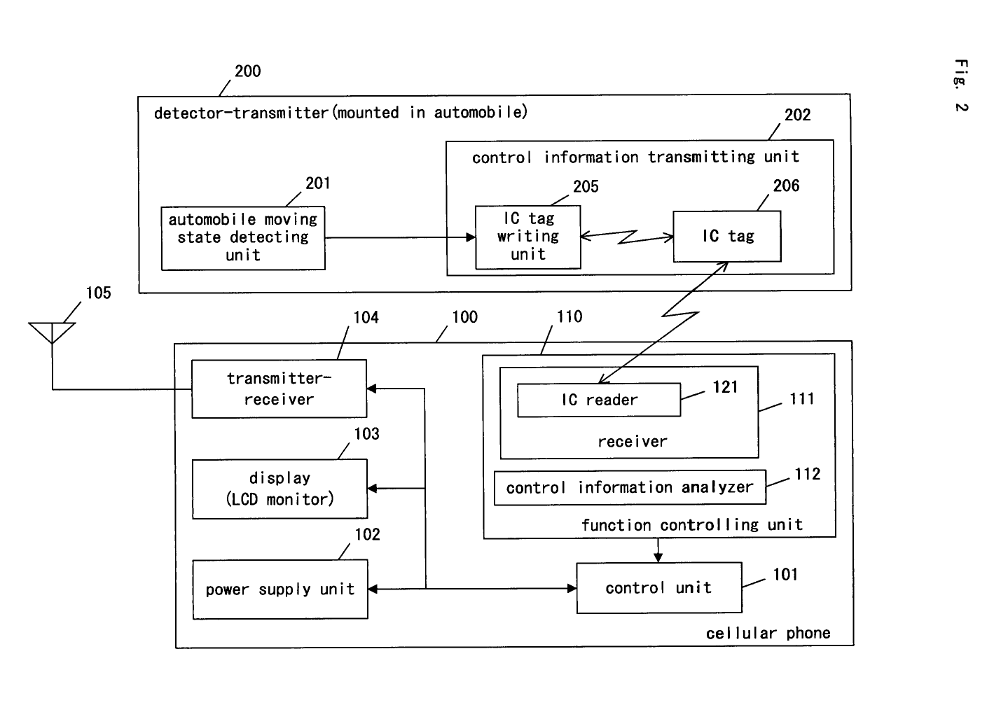

FIG. 2 is the block diagram of the portable information terminal controlling system in the second embodiment of the present invention. In FIG. 2, regarding the same components as in FIG. 1, the same symbols are given and explanation thereof is omitted. Hereinafter, explanation is made referring to FIG. 2.

In the present embodiment, the control information transmitting unit 202 of the detector-transmitter 200 comprises an IC tag writing unit 205 and an IC tag 206. The IC tag 206 is equivalent to the transmitting unit of the present invention. For example, the IC tag 206 is embedded into a wheel of an automobile. The IC tag writing unit 205 is set near to the IC tag 206.

The receiver 111 of the function controlling unit 110 comprises an IC reader 121, accesses to the IC tag 206, and reads the information stored in the IC tag 206. The IC reader 121 is equivalent to the receiving unit of the present invention.

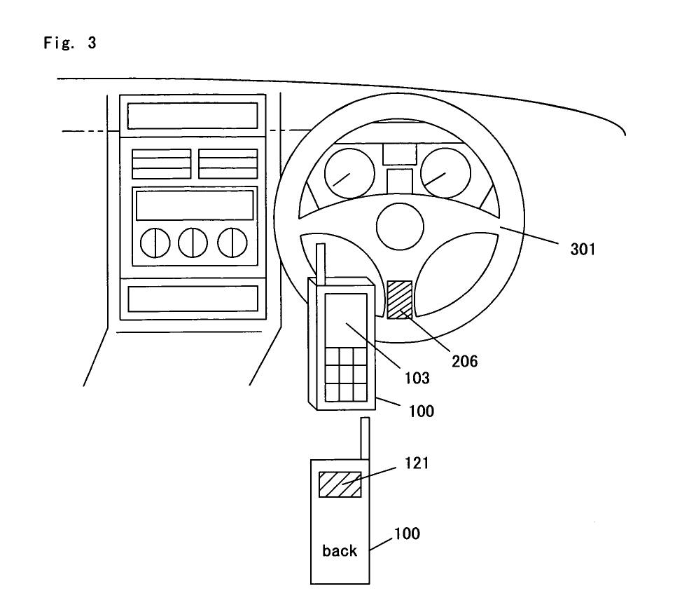

FIG. 3 illustrates a partial view in front of a driver's seat of the automobile and an outline view of the cellular phone 100 in the second embodiment of the present invention. The IC tag 206 is embedded into a part of a wheel 301, and the IC reader 121 is attached in the back of the cellular phone 100.

Hereinafter, operation of the portable information terminal controlling system of the present embodiment is explained referring to FIGS. 2 and 3.

When the automobile moving state detecting unit 201 of the detector-transmitter 200 detects that the automobile is at a moving state, the automobile moving state detecting unit 201 of the detector-transmitter 200 generates control information indicating that the automobile is moving, and sends the generated control information to the control information transmitting unit 202. When the transmitting unit 202 receives the control information, the transmitting unit 202 controls the IC tag writing unit 205, and then writes the control information in the IC tag 206.

When the driver tries to use the cellular phone 100 and looks at the display 103 in front of him/her, the IC reader 121, which is attached in the back of the cellular phone 100 accesses the IC tag 206 that is embedded in the wheel 301, and reads out the control information stored in the IC tag 206. Then, the receiver 111 sends the control information, which the IC reader 121 has read, to the control information analyzer 112. The control information analyzer 112 analyzes the control information sent, and judges that the driver is using the cellular phone 100 while the driver is driving the automobile. The function controlling unit 110 directs the control unit 101 to limit the function of the display 103 and the transmitter-receiver 104, according to the judgment result of the control information analyzer 112.

Since the portable information terminal controlling system of the present embodiment uses the art of RFID, the system judges whether the driver is using the cellular phone 100 or a passenger sitting on the front passenger seat next to the driver's seat or the back passenger seat is using the cellular phone 100, by measuring the strength of the electric wave that the IC reader 121 receives. In the art of RFID, since the communication distance between the IC tag 206 and the IC reader 121 is short, when the driver uses the cellular phone 100, the communication can be performed; however, when the passenger sitting on the front passenger seat or the back passenger seat uses the cellular phone 100, the communication can not be performed. Therefore, when the driver tries to use the cellular phone 100, the above-mentioned function limitation mechanism starts operating, but when the passenger sitting on the front passenger seat or the back passenger seat tries to use the cellular phone 100, the function limitation mechanism does not start operating.

According to the portable information terminal controlling system of the present embodiment, when the driver tries to use the cellular phone while driving the automobile, the function limitation mechanism becomes in active, and the cellular phone becomes hard to use; thereby, traffic accidents due to usage of the cellular phone while driving can be avoided. Since the passengers other than the driver can use the cellular phone 100 without any limitation, the convenience improves.

The setting place of the IC tag 206 may not be a part of the wheel 301. The IC tag 206 may be set at any places near the driver's seat but further from the other seats, suitably selected in accordance with the frequency band to be used for the communication.

An ID tag, which is different from the IC tag of the present embodiment, may be used as long as the art of RFID is used. In short, the limited communication distance and the directivity of communication, as exemplified by the characteristics of RFID, determine whether the driver is using the cellular phone or not. Thus, as long as the features of the limited communication distance and the directivity of the communication are used, any other communication means may be used.

(Third Embodiment)

In a portable information terminal controlling system according to a third embodiment, an IrDA art is used for communication between the detector-transmitter 200 and the cellular phone 100. The IrDA art is a wireless communication art proposed by the Infrared Data Association.

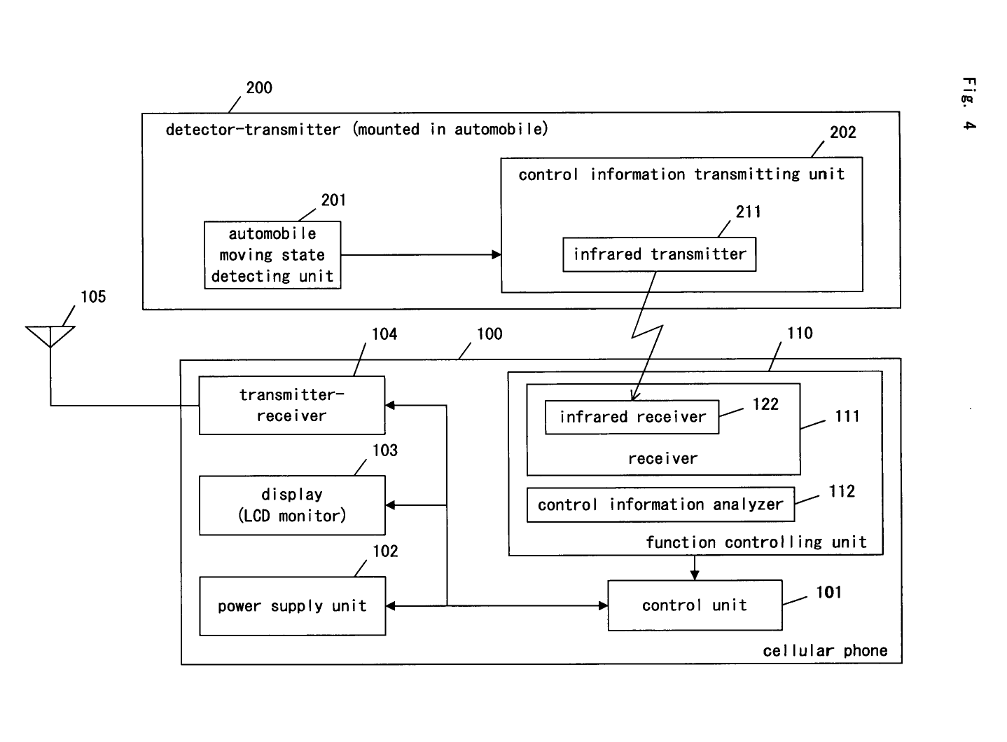

FIG. 4 is a block diagram illustrating the portable information terminal controlling system according to the third embodiment of the present invention. In FIG. 4, regarding the same components as in FIG. 1, the same symbols are given and explanation thereof is omitted.

As illustrated in FIG. 4, in the present embodiment, the control information transmitting unit 202 of the detector-transmitter 200 includes an infrared transmitter 211. The infrared transmitter 211 is equivalent to the transmitting unit of the present invention. The infrared transmitter 211 is installed at a place in front of a driver's seat and far from a passenger seat.

The receiver 111 of the function controlling unit 110 includes an infrared receiver 122, and performs infrared communication with the infrared transmitters 211 of a control information transmitting unit 202. The infrared receiver 122 is equivalent to the receiving unit of the present invention.

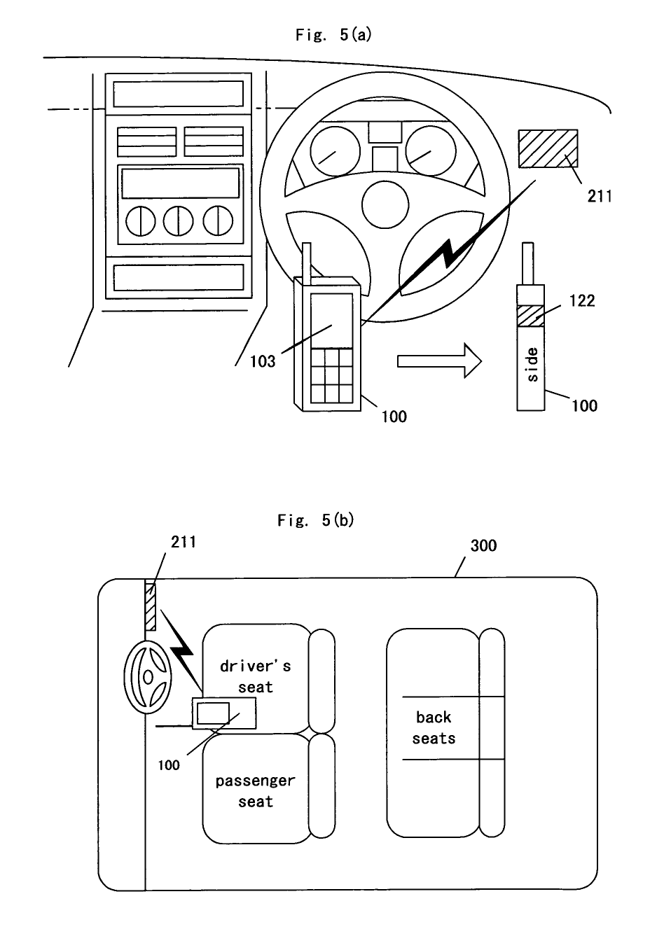

FIG. 5(a) is a partial view in front of the driver's seat of the automobile 300 and an outline view of the cellular phone 100 in the third embodiment of the present invention. FIG. 5(b) is the plane view of the automobile 300 in the third embodiment of the present invention.

As illustrated in FIGS. 5(a) and (b), the infrared transmitter 211 is installed in the front right of the driver's seat. The infrared receiver 122 is installed in the side of the cellular phone 100. When the driver tries to use the cellular phone 100 to look at the display 103, infrared communication becomes possible between the infrared transmitter 211 and the infrared receiver 122.

In the portable information terminal controlling system of the present embodiment illustrated in FIG. 4, the control information transmitting unit 202 of the detector-transmitter 200 sends a signal including control information from the automobile moving state detecting unit 201 to the function controlling unit 110 via the infrared transmitter 211.

In the function controlling unit 110, the infrared receiver 122 of the receiver 111 receives the signal and the control information analyzer 112 analyzes the received signal.

Other operations of the portable information terminal controlling system in the present embodiment are the same as the operations of the portable information terminal controlling system in the first embodiment of the present invention, therefore a description thereof is omitted.

In installing the infrared transmitter 211, by choosing an installation position suitably and adjusting an installation angle suitably, the infrared communication between the cellular phone 100 and the detector-transmitter 200 becomes possible only when the driver holds the cellular phone 100, but not possible when a passenger in the passenger seat or in a backseat holds the cellular phone 100.

Besides the illustration of the FIG. 5(a), the infrared transmitter 211 may be installed in a ceiling of the automobile 300 that is located above the driver's head, and the infrared receiver 122 may be installed in the upper part of the cellular phone 100. Accordingly, a range that the infrared communication is possible can be limited using the linear propagation characteristics of the infrared light and the directivity of the infrared transmitter 211.

According to the portable information terminal controlling system of the present embodiment, when the driver tries to use the cellular phone during driving the automobile, a function limitation mechanism becomes effective and the driver is in a state of being difficult to use the cellular phone. As a result, it is possible to prevent a traffic accident due to operating the cellular phone while the driver is driving the automobile. Since passengers other than the driver can use the cellular phone 100 ordinarily, convenience improves.

(Fourth Embodiment)

A radio wave is used for communication between the detector-transmitter 200 and the cellular phone 100 in a portable information terminal controlling system of a fourth embodiment. A frequency band and electric power and others of the radio wave may be ones that are permitted for local communication. An arbitrary modulation method is also usable.

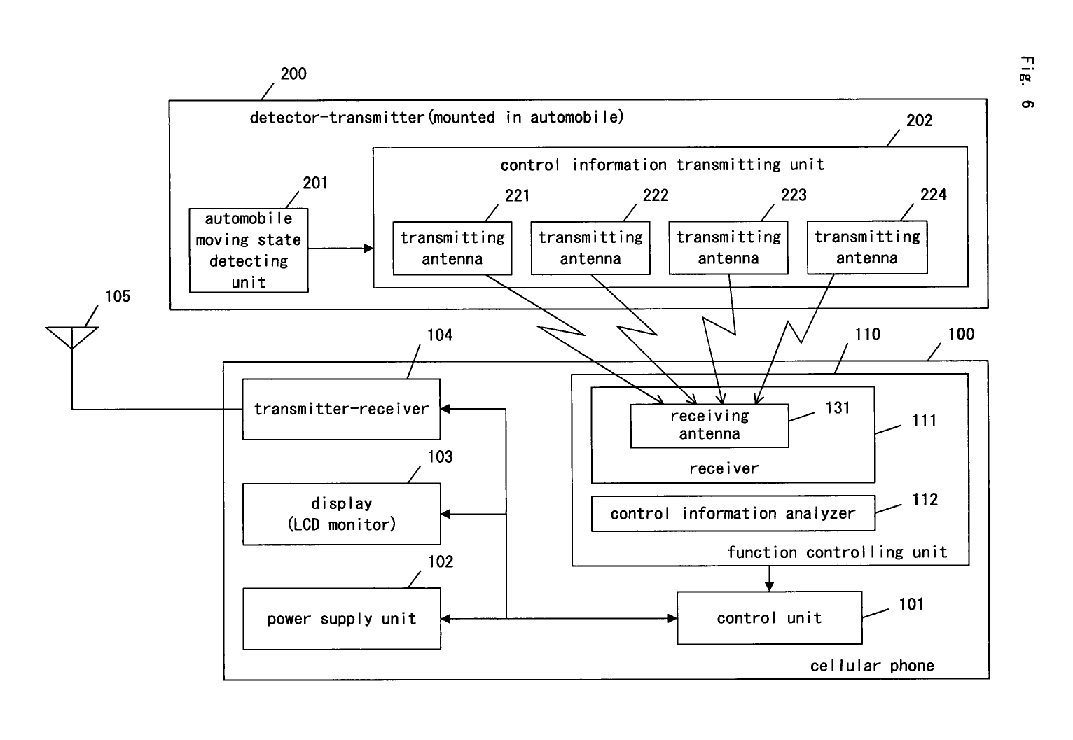

FIG. 6 is a block diagram illustrating the portable information terminal controlling system according to the fourth embodiment of the present invention. In FIG. 6, regarding the same components as in FIG. 1, the same symbols are given and explanation thereof is omitted. Hereafter, FIG. 6 is referred for description.

In the portable information terminal controlling system of the present embodiment, the control information transmitting unit 202 of the detector-transmitter 200 includes four transmitting antennas 221, 222, 223, and 224 installed respectively in positions close to four corners of both sides, back and front of an automobile. The transmitting antennas 221, 222, 223, and 224 are equivalent to a plurality of transmitting units of the present invention.

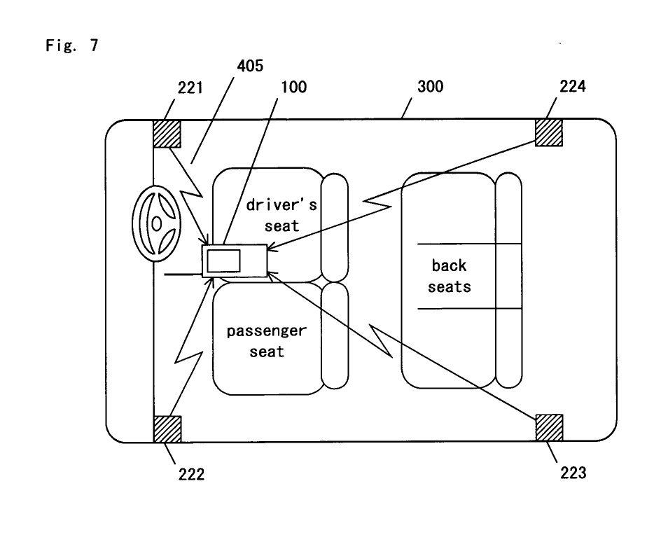

FIG. 7 is a plane view of the automobile 300 in the fourth embodiment of the present invention, and illustrates an arrangement of four transmitting antennas 221, 222, 223, and 224.

The receiver 111 of the function controlling unit 110 includes a receiving antenna 131. The receiving antenna 131 is equivalent to the receiving unit of the present invention. The receiving antenna 131 may be built in a part of a cover of the cellular phone 100, and may be projected outside.

The detector-transmitter 200 transmits control information and ID information identifying the respective transmitting antenna through four transmitting antennas simultaneously. Thus, the transmitting antenna 221 transmits control information and ID information (for example, “ID=1”) identifying the transmitting antenna 221. The transmitting antenna 222 transmits control information and ID information (for example, “ID=2”) identifying the transmitting antenna 222, and so forth.

When the cellular phone 100 communicates with the detector-transmitters 200, the control information analyzer 112 of the function controlling unit 110 receives radio waves from four transmitting antennas 221, 222, 223, and 224, analyzes the control information, decoding ID information of each transmitting antenna, and calculates the position of the cellular phone 100 in the car. The above-mentioned operation is similar to an operation of the so-called GPS (Global Positioning System).

Accordingly, the portable information terminal controlling system of the present embodiment judges whether the cellular phone 100 is used near a driver's seat or in seats other than the driver's seat. When the driver intends to use the cellular phone 100 during driving the automobile, function limitation of the cellular phone 100 becomes effective as in the first embodiment of the present invention.

Thus, according to the portable information terminal controlling system of the present embodiment, when the driver tries to use the cellular phone during driving the automobile, a function limitation mechanism becomes effective and the cellular phone is in the state of being hard to use. As a result, it is possible to prevent a traffic accident due to operating the cellular phone while the driver is driving the automobile. Since passengers other than the driver can use the cellular phone 100 ordinarily, convenience improves.

ID information may be other than what is mentioned above. The transmitting antennas 221, 222, 223, and 224 may transmit simultaneously by using different frequencies, and may transmit by using a same frequency one after another with round robin scheduling. In short, it is sufficient to identify which antenna has transmitted the radio wave that the function controlling unit 110 receives.

(Fifth Embodiment)

A portable information terminal controlling system of a fifth embodiment uses an image recognition art in order to judge that a driver is using the cellular phone 100.

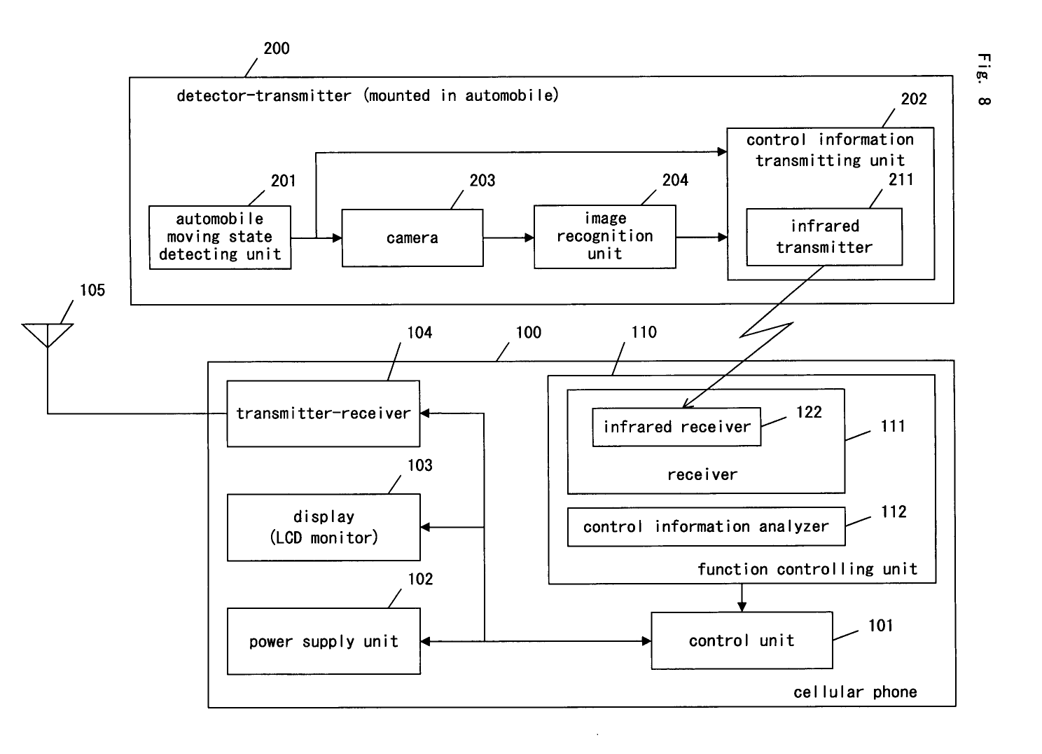

FIG. 8 is a block diagram illustrating the portable information terminal controlling system according to the fifth embodiment of the present invention. In FIG. 8, regarding the same components as in FIG. 1, the same symbols are given and explanation thereof is omitted.

As illustrated in FIG. 8, the detector-transmitter 200 of the present embodiment comprises the automobile moving state detecting unit 201, a camera 203, an image recognition unit 204, and a control information transmitting unit 202. The control information transmitting unit 202 includes the infrared transmitter 211 as in FIG. 4. The infrared transmitter 211 is equivalent to the transmitting unit of the present invention.

The receiver 111 of the function controlling unit 110 includes an infrared receiver 122, and performs infrared communication between the infrared transmitter 211 of the detector-transmitter 200. The infrared receiver 122 is equivalent to the receiving unit of the present invention.

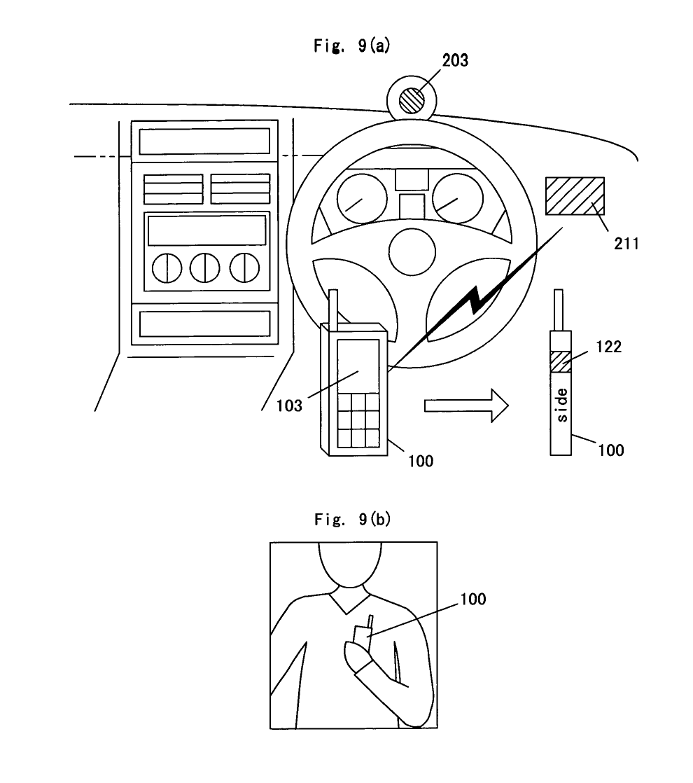

FIG. 9(a) illustrates a partial view in front of a driver's seat in an automobile and an outline view of a cellular phone according to the fifth embodiment of the present invention. The camera 203 is installed in the front of the driver's seat. The infrared transmitter 211 is installed in the front right of the driver's seat. The cellular phone 100 includes the infrared receiver 122 on the side of the cellular phone 100.

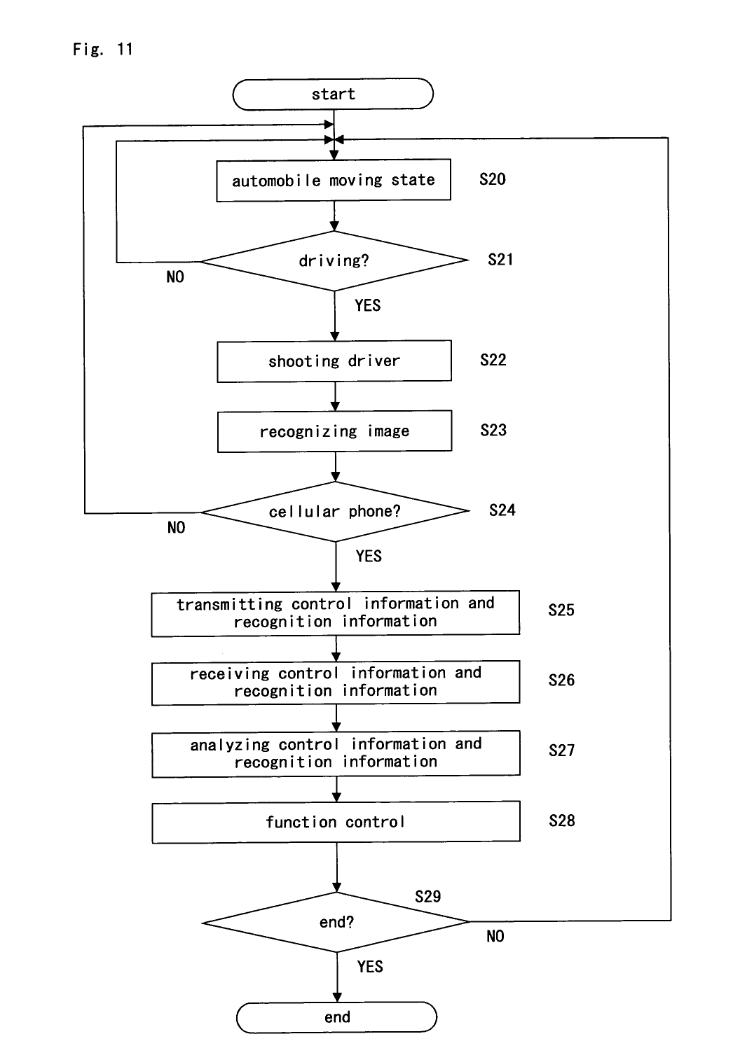

FIG. 11 is a flowchart of the portable information terminal controlling system in the fifth embodiment of the present invention.

Hereinafter, an outline of an operation of the portable information terminal controlling system of the present embodiment is described according to the flowchart illustrated in FIG. 11 with reference to FIG. 8.

In FIG. 11, when the operation of the portable information terminal controlling system begins, in step S20, the automobile moving state detecting unit 201 of the detector-transmitter 200 detects an automobile moving state of the automobile. This detection is the same as in the first embodiment of the present invention.

In step S21, the automobile moving state detecting unit 201 judges whether the automobile is moving. As a result of the judgment, when the automobile is judged moving, the automobile moving state detecting unit 201 generates control information and sends the control information to the control information transmitting unit 202. The control information indicates that the automobile is moving. Simultaneously, the automobile moving state detecting unit 201 sends a shooting instruction to the camera 203, and moves the process to step S22. As a result of the judgment, when the automobile is judged not moving, the process returns to step S20, and steps S20 and S21 are repeated.

In step S22, according to the instruction from the automobile moving state detecting unit 201, the camera 203 shoots the driver and sends an image to the image recognition unit 204.

In step S23, the image recognition unit 204 analyzes the received image to extract the image of the driver and the cellular phone 100 with the image recognition art.

In step S24, the image recognition unit 204 judges whether the cellular phone 100 is extracted. When the image recognition unit 204 judges that the cellular phone 100 is extracted, the image recognition unit 204 judges that the driver is using the cellular phone 100 during driving the automobile.

Then, the image recognition unit 204 generates recognition information and sends the recognition information to the control information transmitting unit 202 and moves the process to step S25. The recognition information indicates that the driver uses the cellular phone 100 during the automobile is moving. When the image recognition unit 204 judges that the cellular phone 100 is not extracted, the image recognition unit 204 returns the process to step S20, and steps S20 to S24 are repeated.

FIG. 9(b) shows a state that the cellular phone 100 that the driver has in his/her hand is recognized as an image by the image recognition unit 204 in the fifth embodiment of the present invention.

Returning to FIG. 11, in step S25, the control information transmitting unit 202 receives the control information from the automobile moving state detecting unit 201, and the control information transmitting unit 202 also receives the recognition information from the image recognition unit 204, and sends the control information and the recognition information to the function controlling unit 110 via the infrared transmitter 211.

In step S26, the receiver 111 of the function controlling unit 110 receives the control information and the recognition information that has been sent from the detector-transmitter 200 via the infrared receiver 122, and sends the control information and the recognition information to the control information analyzer 112.

In step S27, the control information analyzer 112 analyzes the received control information and the received recognition information. In the present embodiment, control information includes information that the automobile is moving, and recognition information includes information that the driver uses the cellular phone 100. Therefore, the analysis of whether the driver uses the cellular phone 100 during driving of the automobile is comparatively easy.

In step S28, the function controlling unit 110 instructs necessary function limitation to the control unit 101. The function limitation of the cellular phone 100 that the control unit 101 performs is the same as in the first embodiment of the present invention.

In step S29, the portable information terminal controlling system judges whether the operation to be ended. When the operation does not end, the process returns to step S20 and a series of steps described above are repeated.

Thus, when the portable information terminal controlling system of the present embodiment recognizes the cellular phone 100 in the image that is shot by the camera 203, it is judged that the driver is using the cellular phone 100 during driving the automobile. Then, the same function limitation for the cellular phone as in the first embodiment of the present invention is performed. When the portable information terminal controlling system of the present embodiment does not recognize the cellular phone 100 in the image that is shot by the camera 203, function limitation for the cellular phone is not performed.

Thus, according to the portable information terminal controlling system of the present embodiment, when the driver tries to use the cellular phone during driving the automobile, the function limitation mechanism becomes effective and the cellular phone is in the state of being hard to use. As a result, it is possible to prevent a traffic accident due to operating the cellular phone while the driver is driving the automobile. Since passengers other than the driver can use the cellular phone 100 ordinarily, convenience improves.

Communication between the detector-transmitter 200 and the function controlling unit 110 is not limited to the infrared communication of the present embodiment. The RFID art as in the second embodiment, the IrDA art as in the third embodiment, and the general radio wave as in the fourth embodiment may be alternatively used in the communication between the detector-transmitter 200 and the function controlling unit 110.

In short, it is sufficient that the communication between the detector-transmitter 200 and the function controlling unit 110 is secured. The position of the cellular phone 100 is not necessary to be pinpointed, based on the reception signal.

As described above, the object of the present invention is as follows. The portable information terminal controlling system judges whether a portable information terminal (or a cellular phone) is used while a driver is driving an automobile, at least one of display and communication functions of the portable information terminal is limited and the driver is prevented from using the portable information terminal during driving the automobile. Therefore, an accident that is caused by the driver's use of the cellular phone during driving the automobile is suppressed. The embodiments described above are examples of the object of the present invention, and various changes are possible unless deviating from the object of the present invention.

According to the present invention, the portable information terminal controlling system and the related art can be provided, thereby limiting use of a cellular phone while an automobile is moving and usefully preventing an accompanying traffic accident.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A portable information terminal controlling system for limiting functions of a portable information terminal used in an automobile when moving, said portable information terminal controlling system comprising:
a detector-transmitter comprising an automobile moving state detecting unit and a control information transmitting unit; and
a portable information terminal comprising a display unit, a transmitter-receiver, and a function controlling unit,
wherein said automobile moving state detecting unit is operable to detect moving state of the automobile and to generate control information indicating that the automobile is moving when the automobile is judged moving,
wherein said control information transmitting unit is operable to transmit the control information to said portable information terminal, and
wherein when said portable information terminal receives the control information, said function controlling unit is operable to limit functions of at least one of said display unit and said transmitter-receiver.

2. A portable information terminal controlling system for limiting functions of a portable information terminal used in an automobile when moving, said portable information terminal controlling system comprising:
a detector-transmitter comprising an automobile moving state detecting unit and a control information transmitting unit; and
a portable information terminal comprising a display unit, a transmitter-receiver, and a function controlling unit,
wherein said automobile moving state detecting unit is operable to detect moving state of the automobile and to generate control information indicating that the automobile is moving when the automobile is judged moving,
wherein said control information transmitting unit is operable to transmit a signal including the control information to said portable information terminal, and
wherein when said portable information terminal receives the signal, said function controlling unit is operable to limit functions of at least one of said display unit and said transmitter-receiver when a driver of the automobile is judged, based on the received signal and the control information included therein, using said portable information terminal while the driver is driving the automobile.

3. The portable information terminal controlling system as defined in claim 2,
wherein said control information transmitting unit comprises a transmitting unit mounted at a position nearer to a driver's seat but further from other seats than the driver's seat in the automobile,
wherein said function controlling unit comprises a control information analyzer and a receiver including a receiving unit, said control information analyzer and said receiver being installed in said portable information terminal,
wherein said detector-transmitter is operable to transmit the signal including the control information to said portable information terminal, using wireless communication between said transmitting unit and said receiving unit, and
wherein said control information analyzer is operable to judge whether the driver of the automobile is using said portable information terminal, by analyzing the signal including the control information received by said receiving unit.

4. The portable information terminal controlling system as defined in claim 2,
wherein said control information transmitting unit comprises a plurality of transmitting units, each of said plurality of transmitting units being mounted at different positions in the automobile,
wherein said function controlling unit comprises a control information analyzer and a receiver including a receiving unit, said control information analyzer and said receiver being installed in said portable information terminal,
wherein said detector-transmitter is operable to transmit signals including the control information to said portable information terminal, using wireless communication between each of said plurality of transmitting units and said receiving unit, and
wherein said control information analyzer is operable to judge whether the driver of the automobile is using said portable information terminal, by analyzing the signals including the control information sent by said plurality of transmitting units and received by said receiving unit.

5. The portable information terminal controlling system as defined in claim 3,
wherein said transmitting unit is composed of an IC tag and said receiving unit is composed of an IC tag reader, and
wherein the wireless communication between said transmitting unit and said receiving unit is performed using RFID.

6. The portable information terminal controlling system as defined in claim 3,
wherein said transmitting unit is composed of an infrared transmitter and said receiving unit is composed of an infrared receiver operable to receive infrared light transmitted by said infrared transmitter, and
wherein the wireless communication between said transmitting unit and said receiving unit is performed using infrared communication.

7. A portable information terminal controlling system for limiting functions of a portable information terminal used in an automobile when moving, said portable information terminal controlling system comprising:
a detector-transmitter comprising an automobile moving state detecting unit, a camera, an image recognition unit, and a control information transmitting unit;
a portable information terminal comprising a display unit, a transmitter-receiver, and a function controlling unit,
wherein the automobile moving state detecting unit is operable to detect moving state of the automobile and to generate control information indicating that the automobile is moving when the automobile is judged moving,
wherein said camera is operable to take a photograph of a driver of the automobile,
wherein said image recognition unit is operable to detect an image of said portable information terminal from the photograph taken by said camera, thereby generating recognition information based on the detected result,
wherein said control information transmitting unit is operable to transmit a signal including the control information and the recognition information to said portable information terminal, and
wherein when said portable information terminal receives the signal, said control information analyzer is operable to analyze the signal, and said function controlling unit is operable to limit functions of at least one of said display unit and said transmitter-receiver when the driver of the automobile is judged, based on the analyzed result, using said portable information terminal while the driver is driving the automobile.

8. The portable information terminal controlling system as defined in claim 1, wherein said function controlling unit is operable to cut off a power supply for said display unit of said portable information terminal, thereby limiting functions of said portable information terminal.

9. The portable information terminal controlling system as defined in claim 1, wherein said function controlling unit is operable to switch an image displayed on said display unit of said portable information terminal to a predetermined image, thereby limiting functions of said portable information terminal.

10. The portable information terminal controlling system as defined in claim 1, wherein said function controlling unit is operable to disable a sending function and a receiving function of said portable information terminal, thereby limiting functions of said portable information terminal.

11. The portable information terminal controlling system as defined in claim 1, wherein said function controlling unit is operable to disable a receiving function of said portable information terminal and to limit destinations to which said portable information terminal sends messages, thereby limiting functions of said portable information terminal.

12. The portable information terminal controlling system as defined in claim 1, wherein said function controlling unit is operable to cut off a power supply for said portable information terminal, thereby limiting functions of said portable information terminal.

13. A detecting-transmitting device mounted in an automobile, said detecting-transmitting device comprising:
an automobile moving state detecting unit; and
a control information transmitting unit,
wherein said automobile moving state detecting unit is operable to detect moving state of the automobile and to generate control information indicating that the automobile is moving when the automobile is judged moving, and
wherein said control information transmitting unit is operable to transmit the control information to the exterior of said detecting-transmitting device.

14. A detecting-transmitting device mounted in an automobile, said detecting-transmitting device comprising:
an automobile moving state detecting unit;
a camera;
an image recognition unit; and
a control information transmitting unit,
wherein said automobile moving state detecting unit is operable to detect moving state of the automobile and to generate control information indicating that the automobile is moving when the automobile is judged moving,
wherein said camera is operable to take a photograph of a driver of the automobile,
wherein said image recognition unit is operable to detect an image of a portable information terminal from the photograph taken by said camera, thereby generating recognition information based on the detected result,
wherein said control information transmitting unit is operable to transmit a signal including the control information and the recognition information to the exterior of said detecting-transmitting device.

15. A portable information terminal used in an automobile, said portable information terminal comprising:
a display unit;
a transmitter-receiver; and
a function controlling unit,
wherein when said transmitter-receiver receives a signal including at least one of control information and recognition information, said function controlling unit is operable to limit functions of at least one of said display unit and said transmitter-receiver when the received signal is judged to indicate that a driver of the automobile is using said portable information terminal while the driver is driving the automobile.

16. A portable information terminal controlling method for limiting functions of a portable information terminal used in an automobile when moving, said portable information terminal controlling method comprising:
detecting moving state of the automobile;
generating control information indicating that the automobile is moving when the automobile is judged moving;
transmitting the control information generated in said generating to the portable information terminal;
receiving the control information; and
limiting functions of at least one of the display unit and the transmitter-receiver of the portable information terminal, based on the control information received by said receiving.

17. A portable information terminal controlling method for limiting functions of a portable information terminal used in an automobile when moving, said portable information terminal controlling method comprising:
detecting moving state of the automobile;
generating control information indicating that the automobile is moving when the automobile is judged moving;
transmitting a signal including the control information generated in said generating to the portable information terminal;
receiving the signal transmitted in said transmitting,
analyzing the signal and the control information included therein to judge if a driver of the automobile uses the portable information terminal, and
limiting functions of at least one of the display unit and the transmitter-receiver of the portable information terminal when the driver of the automobile is judged, in said analyzing, using the portable information terminal while the driver is driving the automobile.

18. The portable information terminal controlling method as defined in claim 17,
wherein said transmitting uses a transmitting unit mounted at a position nearer to a driver's seat but further from other seats than the driver's seat in the automobile,
wherein said receiving uses a receiving unit mounted in the portable information terminal,
wherein said transmitting is performed by using wireless communication between the transmitting unit and the receiving unit, and
wherein said analyzing the signal and the control information included therein judges if the driver of the automobile is using the portable information terminal, based on the signal received in said receiving.

19. The portable information terminal controlling method as defined in claim 17,
wherein said transmitting uses a plurality of transmitting units, each of the plurality of the transmitting units being mounted at different positions in the automobile,
wherein said receiving uses a receiving unit mounted in the portable information terminal,
wherein said transmitting is performed by using wireless communication between each of the plurality of transmitting units and the receiving unit, and
wherein said analyzing the signal and the control information included therein judges if the driver of the automobile is using the portable information terminal, based on the signal received in said receiving.

20. The portable information terminal controlling method as defined in claim 17, wherein the wireless communication is performed using RFID, and
wherein the transmitting unit is composed of an IC tag and the receiving unit is composed of an IC tag reader.

21. The portable information terminal controlling method as defined in claim 18,
wherein the wireless communication is preformed using infrared communication, and
wherein the transmitter unit is composed of an infrared transmitter and the receiving unit is composed of an infrared receiver.

22. A portable information terminal controlling method for limiting functions of a portable information terminal used in an automobile when moving, said portable information terminal controlling method comprising:
detecting moving state of the automobile;
generating control information indicating that the automobile is moving when the automobile is judged moving;
taking a photograph of a driver of the automobile,
recognizing an image of the portable information terminal from the photograph taken in said taking a photograph, thereby generating recognition information,
transmitting a signal including the control information and the recognition information to the portable information terminal;
receiving the signal transmitted in said transmitting,
analyzing the signal to judge if the driver of the automobile uses the portable information terminal, and
limiting functions of at least one of the display unit and the transmitter-receiver of the portable information terminal when the driver of the automobile is judged in said analyzing using the portable information terminal while the driver is driving the automobile.

23. The portable information terminal controlling method as defined in claim 16, wherein said limiting cuts off a power supply for the display unit, thereby limiting functions of the portable information terminal.

24. The portable information terminal controlling method as defined in claim 16, wherein said limiting switches an image displayed on the display unit of the portable information terminal to a predetermined image, thereby limiting functions of the portable information terminal.

25. The portable information terminal controlling method as defined in claim 16, wherein said limiting disables a sending function and a receiving function of the portable information terminal, thereby limiting functions of the portable information terminal.

26. The portable information terminal controlling method as defined in claim 16, wherein said limiting disables a receiving function of the portable information terminal and to limit destinations to which the portable information terminal sends messages, thereby limiting functions of the portable information terminal.

27. The portable information terminal controlling method as defined in claim 16, wherein said limiting cuts off a power supply for the portable information terminal, thereby limiting functions of the portable information terminal.
